(19) United States
(12) Patent Application Publication
(10) Pub. No.: US 2026/0192656 A1
(43) Pub. Date: Jul. 9, 2026

(54) ACTIVE AIR FLAP DEVICE

(71) Applicants: HYUNDAI MOTOR COMPANY, Seoul (KR); KIA CORPORATION, Seoul (KR); HYUNDAI MOBIS CO., LTD., Seoul (KR)

(72) Inventors: Jin Young Yoon, Hwaseong-si (KR); Hong Heui Lee, Hwaseong-si (KR); Dong Ha Kim, Hwaseong-si (KR); Jae Sup Byun, Yongin-si (KR); Jang Ho Kim, Seoul (KR)

(73) Assignees: HYUNDAI MOTOR COMPANY, Seoul (KR); KIA CORPORATION, Seoul (KR); HYUNDAI MOBIS CO., LTD., Seoul (KR)

(21) Appl. No.: 19/251,218

(22) Filed: Jun. 26, 2025

(30) Foreign Application Priority Data
Jan. 9, 2025 (KR) 10-2025-0003156

(51) Int. Cl. B60K 11/08

(52) U.S. Cl. CPC B60K 11/085

(57) ABSTRACT

An active air flap device may include a flap and a plurality of links configured to move the flap between an open position and a closed position. The plurality of links may include a slide link coupled to the flap, and a first link rotatably coupled to the slide link and configured to rotate to linearly move the slide link.

### CROSS-REFERENCE TO RELATED APPLICATION

This application claims, under 35 U.S.C. § 119(a), the benefit of and priority to Korean Patent Application No. 10-2025-0003156, filed on Jan. 9, 2025, the entire contents of which are incorporated herein by reference.

### TECHNICAL FIELD

The present disclosure relates to an aerodynamic component of a vehicle.

### BACKGROUND

An object moving in or through the air experiences an aerodynamic force due to the relative motion of the object and the air. An aerodynamic force includes a lift force perpendicular to the direction of relative motion and a drag force parallel to the direction of relative motion.

Aerodynamic force also acts on a travelling vehicle by the relative motion with the air. Improving the aerodynamic force of a vehicle is an important task in vehicle development because it can improve the travel stability of the vehicle and improve power efficiency or fuel efficiency of the vehicle.

For this reason, recently, active aerodynamic components that are variably controlled depending on the vehicle's travelling speed are being mounted on or installed in vehicles.

The above information disclosed in this Background section is only for enhancement of understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and an object of the present disclosure is to provide an active air flap device capable of improving aerodynamic force performance of a vehicle.

Another object of the present disclosure is to provide an active air flap device capable of improving fuel efficiency or power efficiency of a vehicle.

Still another object of the present disclosure is to provide an active air flap device having expanded functions.

The objects of the present disclosure are not limited to the foregoing, and other objects not mentioned herein should be clearly understood by one having ordinary skill in the art to which the present disclosure pertains based on the description below.

The features of the present disclosure to achieve the objects of the present disclosure as described above and to perform the characteristic functions of the present disclosure to be described below are as follows.

According to some embodiments of the present disclosure, an active air flap device may include a flap, and a plurality of links configured to move the flap between an open position and a closed position. The plurality of links may include a slide link coupled to the flap, and a first link rotatably coupled to the slide link and configured to rotate to linearly move the slide link.

According to some embodiments of the present disclosure, an active air flap device may include a flap, a plurality of links configured to move the flap between an open position and a closed position, an actuator configured to provide a rotational force to the plurality of links, and a controller configured to control the actuator so that the flap executes one or more operation modes. The plurality of links may include a slide link coupled to the flap, and a first link rotatably coupled to the slide link and configured to rotate to linearly move the slide link.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are described in detail below with reference to certain embodiments thereof illustrated in the accompanying drawings which are given herein below by way of illustration only, and thus are not limitative of the present disclosure, and wherein:

FIG. 1 illustrates a vehicle;

FIG. 2 illustrates an active air flap device according to some embodiments of the present disclosure and a grille portion of a vehicle to which the device may be mounted;

FIG. 3 illustrates an active air flap device according to some embodiments of the present disclosure and a bumper portion of a vehicle to which the device may be mounted;

FIG. 4A illustrates an active air flap device according to some embodiments of the present disclosure in a closed position;

FIG. 4B illustrates an active air flap device according to some embodiments of the present disclosure in an open position;

FIG. 5 is an exploded view of an active air flap device according to some embodiments of the present disclosure;

FIG. 6A illustrates an active air flap device according to some embodiments of the present disclosure in a closed position;

FIG. 6B illustrates an active air flap device according to some embodiments of the present disclosure in an open position;

FIGS. 7A and 7B illustrate the operation of a link of an active air flap device according to some embodiments of the present disclosure;

FIG. 8 illustrates a guide for a slide link of an active air flap device according to some embodiments of the present disclosure;

FIG. 9A illustrates a flap arranged in a guide passage in a closed position of an active air flap device according to some embodiments of the present disclosure;

FIG. 9B illustrates a flap arranged in a guide passage in an open position of an active air flap device according to some embodiments of the present disclosure;

FIGS. 10A and 10B illustrate side views of an active air flap device according to some embodiments of the present disclosure in a closed position and in an open position, respectively;

FIG. 11 illustrates a front view of an active air flap device according to an embodiment of the present disclosure;

FIG. 12A illustrates a side view of an active air flap device according to an embodiment of the present disclosure;

FIG. 12B is a partial enlarged view of an actuator of FIG. 12A;

FIG. 13 is a table to show the control of an actuator in opening and closing modes of an active air flap device according to an embodiment of the present disclosure;

FIG. 14 is a table to show the control of an actuator in a welcome mode of an active air flap device according to an embodiment of the present disclosure; and

FIG. 15 is a table to show the control of an actuator in an emergency light mode of an active air flap device according to an embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of the embodiments of the present disclosure.

It should be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” and the like).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising”, or “includes” and/or “including”, used in this specification mean that the cited component, step, operation, and/or element does not exclude the presence or addition of one or more of other components, steps, operations, and/or elements.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

Hereinafter, the present disclosure is described in detail with reference to the accompanying drawings.

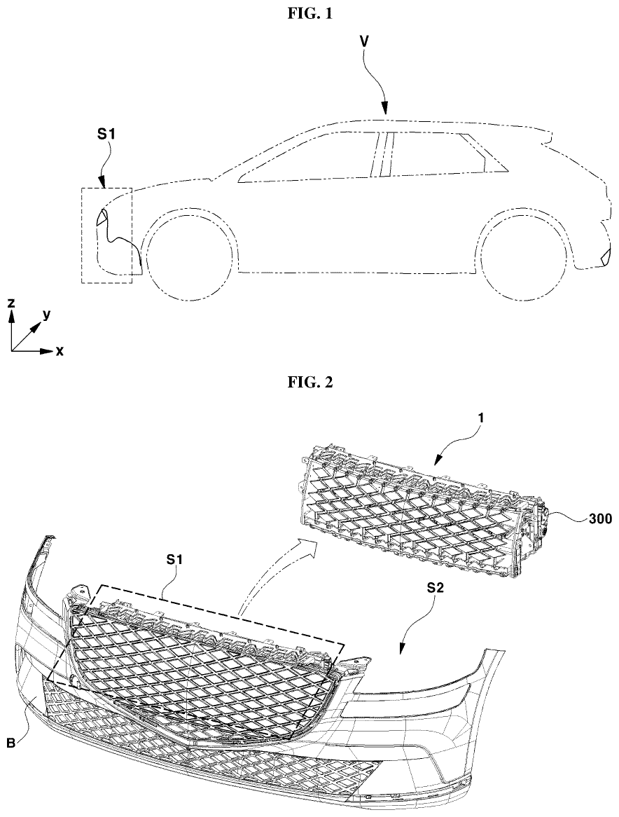

As illustrated in FIG. 1, according to the present disclosure, a vehicle V may include an active air flap device 1. In one implementation, the active air flap device 1 may be arranged in a front region S1 of the vehicle V. In FIG. 1, x denotes a length direction of the vehicle V, y denotes a lateral direction of the vehicle V, and z denotes a vertical direction.

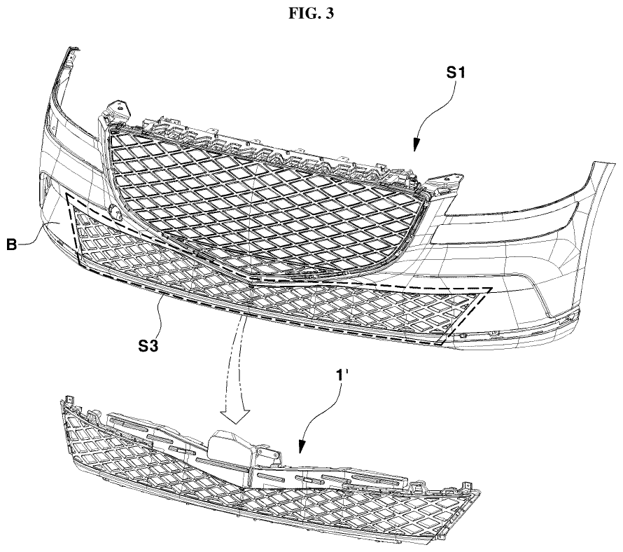

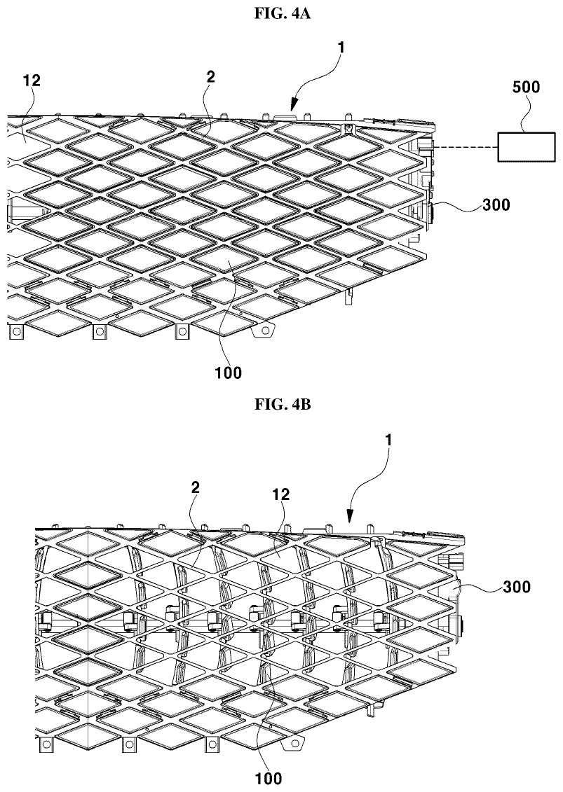

As illustrated in FIG. 2, in some implementations, the active air flap device 1 may be arranged in a grille portion S2 or a radiator grille portion of the vehicle V in the front region S1. In some implementations, as illustrated in FIG. 3, an active air flap device 1′ may be arranged in a region S3 in a bumper B in the front region S1 of the vehicle V. Hereinafter, the active air flap device 1 arranged in the grille portion S2 of the vehicle V is described as an example, but the active air flap device 1 of the present disclosure may also be provided in the region S3.

The active air flap device 1 may be controlled to be opened or closed. While the vehicle is travelling, air resistance may be reduced by closing the active air flap device 1. Moreover, air needed for cooling (e.g., cooling the engine and/or the interior of the vehicle) during traveling may be introduced by opening the active air flap device 1. For example, the air being introduced may keep the temperature of the drivetrain of the engine or motor within an appropriate range.

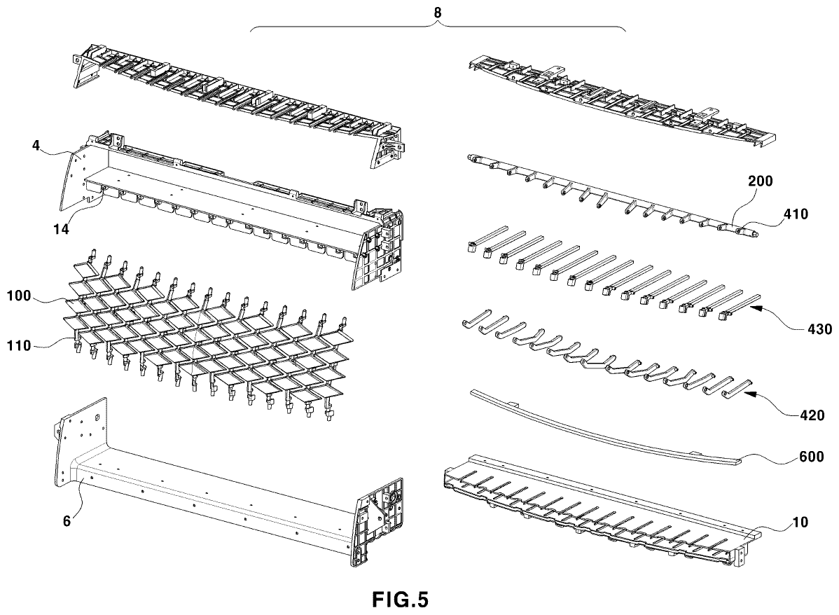

As illustrated in FIGS. 4A and 4B, the active air flap device 1 may be placed in a closed position (FIG. 4A) or in an open position (FIG. 4B). Moreover, the active air flap device 1 may also be placed in a position between the closed position and the open position. The active air flap device 1 may be placed in the closed position, in the open position, or in the position between the closed position and the open position depending on the state of the vehicle V.

The active air flap device 1 includes one or more flaps 100. The flaps 100 may be referred to herein at times in the singular (i.e., as a flap 100) for the ease of describing the structure and functions thereof and for the sake of brevity, but any such description may apply to all flaps 100 as well. The flaps 100 are configured to move. Specifically, the flaps 100 are configured to be linearly movable and rotatable. The flaps 100 may receive moving force and rotational force through a drive rod 200 and an actuator 300. In one implementation, the flaps 100 are configured to rotate with respect to a frame 2. The frame 2 may rotatably support an end portion of the flaps 100. In the closed position, a flap 100 may be positioned to close an opening 12 formed by the frame 2. In the open position or in the position between the open position and the closed position, the flap 100 may be positioned to open the opening 12 formed by the frame 2. In some implementations, the frame 2 may be omitted. In other words, only the flaps 100 without the frame 2 may be configured to open and close the grille portion S2.

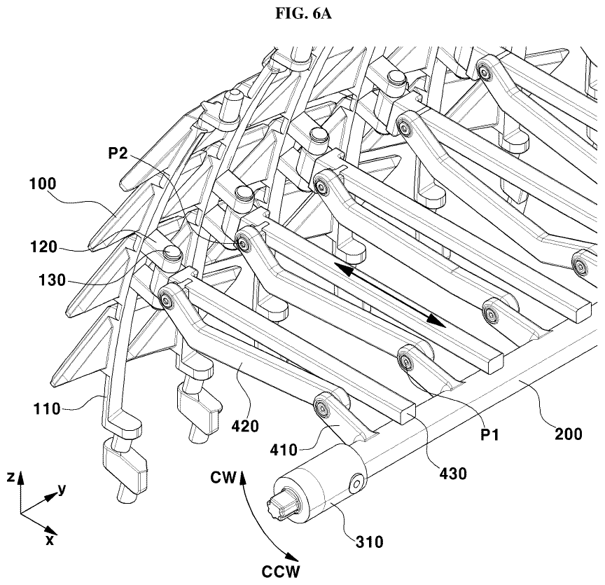

Referring to FIG. 5, the active air flap device 1 may further include a housing 4, 6. In one implementation, the flaps 100 may be operably associated with the housing 4, 6. In one implementation, the housing 4, 6 includes an upper housing 4 and a lower housing 6. The flaps 100 or the frame 2 of the flaps 100 may be coupled to the upper housing 4. The lower housing 6 may be coupled to a lower portion of the upper housing 4.

In one implementation, the active air flap device 1 may further include a cover 8, 10 configured to surround the housing 4, 6. The cover 8, 10 may include an upper cover 8 and a lower cover 10. The upper cover 8 may be coupled to an upper portion of the upper housing 4, and the lower cover 10 may be coupled to a lower portion of the lower housing 6. In some implementations, opposite end portions of the flaps 100 may be rotatably supported by the upper cover 8 and the lower cover 10, respectively. For example, when the frame 2 is not provided, the opposite end portions of the flaps 100 may be supported by the covers 8 and 10.

The active air flap device 1 may include the drive rod 200 and a link 400 or links 400 configured to operably associate the actuator 300 with the flaps 100. Differently put, the driving force of the actuator 300 may be transmitted to the flaps 100 by the drive rod 200 and the links 400.

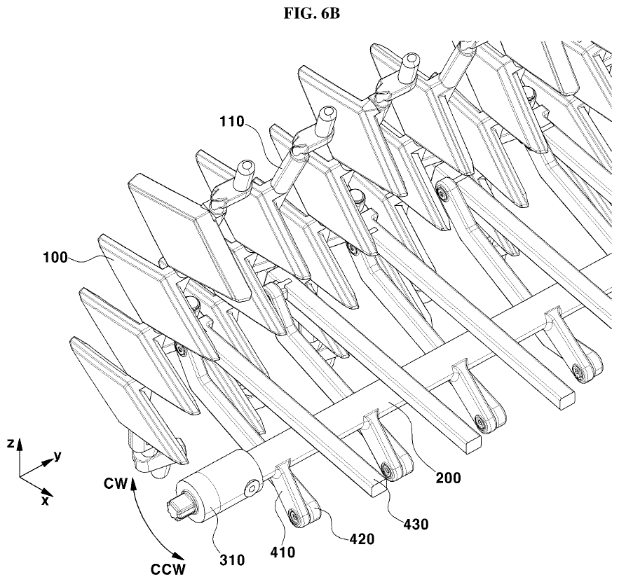

As illustrated in FIG. 6A, each of the links 400 may include a proximal link 410, a distal link 420, and a slide link 430. In one implementation, the proximal link 410 may be integrated with the drive rod 200. In another implementation, the proximal link 410 may be separately provided from the drive rod 200 but coupled to the drive rod 200. The proximal link 410 may protrude radially outwardly from the drive rod 200. The proximal link 410 may rotate about a first pivot point P1.

The distal link 420 may be connected to the proximal link 410 at the first pivot point P1. The distal link 420 is configured to rotate about the first pivot point P1. The distal link 420 may also be connected to one of the flaps 100. Differently put, a first end portion of the distal link 420 may be rotatably connected to the proximal link 410 at the first pivot point P1, and a second end portion of the distal link 420 may be connected to the flap 100. The second end portion of the distal link 420 may also be connected to the flap 100 via the slide link 430. The second end portion of the distal link 420 may be connected to the slide link 430 to rotate about a second pivot point P2. The slide link 430 fixedly coupled to the second pivot point P2 of the distal link 420 is configured to linearly move by the distal link 420 rotating about the second pivot point P2.

The slide link 430 may be mounted to the flap 100. In one implementation, the flap 100 may include a connecting portion 110 and a coupling portion 120. The connecting portion 110 is configured to connect each flap 100 to one another. For example, as in the illustrated implementation, the connecting portion 110 may interconnect the flaps 100 that are arranged generally in the vertical direction z or in a line. In one implementation, the coupling portion 120 may be provided on the connecting portion 110. The slide link 430 may be coupled to the coupling portion 120. In one implementation, the slide link 430 may be coupled to the coupling portion 120 by a pin 130. The flap 100 is configured to be rotatable with respect to the pin 130.

The active air flap device 1 in the closed position in FIG. 6A may be moved to the open position as illustrated in FIG. 6B by the operation of the drive rod 200 and the links 400. The drive rod 200 is operably connected to the actuator 300. For example, the drive rod 200 is configured to rotate by being connected to the actuator 300 via a connector 310.

When the drive rod 200 rotates counterclockwise CCW in the closed position of the flaps 100, the proximal links 410 integrated with the drive rod 200 or connected to the drive rod 200 also rotates together with the drive rod 200. By the rotation of the proximal links 410, the distal links 420 coupled to the proximal links 410 may rotate about the first pivot point P1. At the same time, the distal links 420 move downward in a generally −z-axis direction by the proximal links 410 and moves in an x-axis direction.

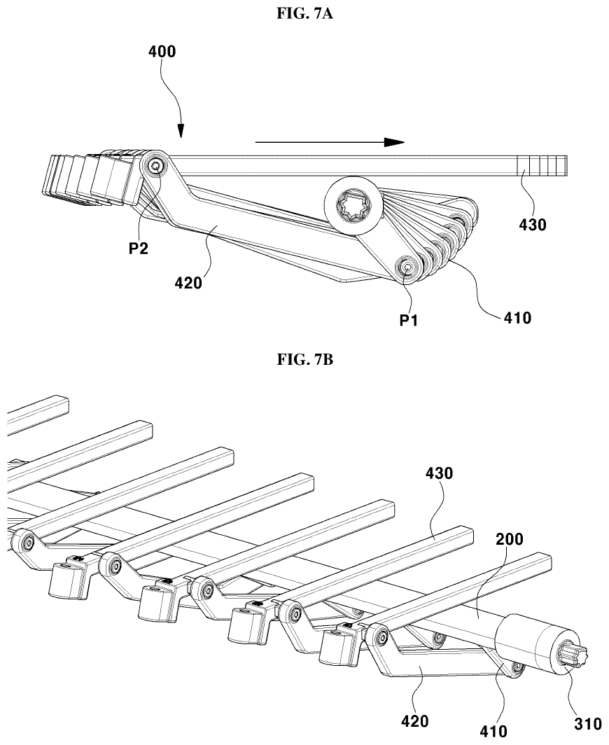

By such movement of the distal link 420, the second end portion of the distal link 420 also rotates and is pulled in the x-axis direction. Accordingly, as illustrated in FIGS. 7A and 7B, the slide link 430 coupled to the distal link 420 at the second pivot point P2 is also pulled in the x-axis direction and linearly moved in the x-axis direction. Therefore, the flap 100 coupled to the slide link 430 may linearly move in the x-axis direction.

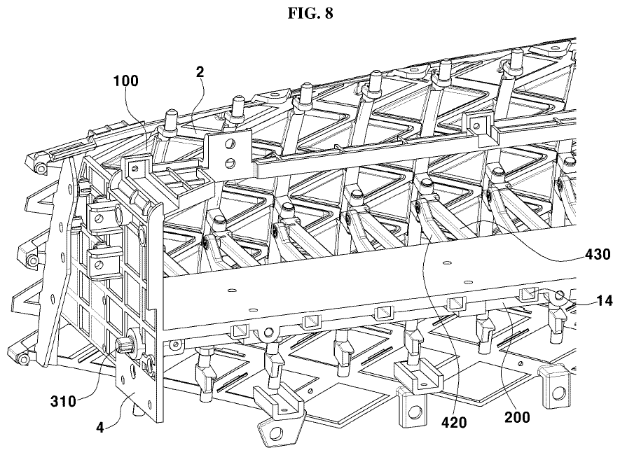

As illustrated in FIG. 8, the active air flap device 1 may include a guide 14. The guide 14 is configured to guide the movement of the slide links 430. In one example, the guide 14 may be formed in the upper housing 4.

By the linear movement of the slide links 430, the flaps 100 coupled to the slide links 430 may move toward the drive rod 200 or move in the x-axis direction to move from the closed position to the open position.

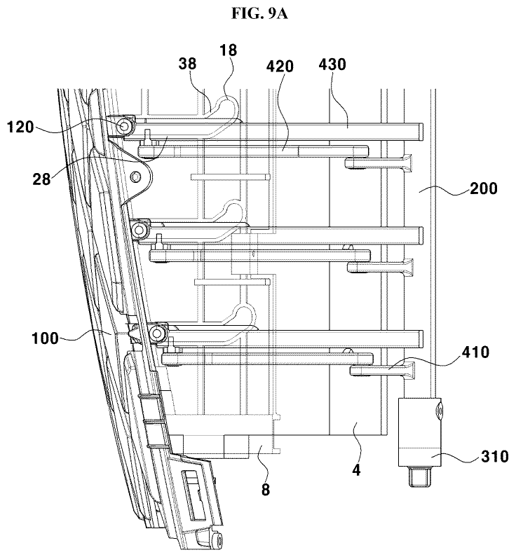

According to an implementation of the present disclosure, the flaps 100 are configured to rotate while being opened. As illustrated in FIGS. 9A and 9B, in one implementation, the flap 100 or the coupling portion 120 of the flap 100 may rotate while the movement path of the flap 100 or the coupling portion 120 of the flap 100 is guided by a guide passage 18. The guide passage 18 includes a linear passage 28 and an oblique passage 38.

The linear passage 28 extends from an open end of the guide passage 18, and when the coupling portion 120 is at the open end of the guide passage 18, the flap 100 is placed in the closed position. The oblique passage 38 extends at an angle with respect to the linear passage 28. For example, the oblique passage 38 may extend in a generally arc shape. The oblique passage 38 extends to a closed end of the guide passage 18. When the coupling portion 120 is at the closed end of the guide passage 18, the flap 100 may be placed in the open position. In one example, the open end and the closed end of the guide passage 18 may form an angle of approximately 90°.

The active air flap device 1 may include a structure for the guide passage 18. In one example, the guide passage 18 may be formed in the upper cover 8 arranged at the upper portion of the upper housing 4.

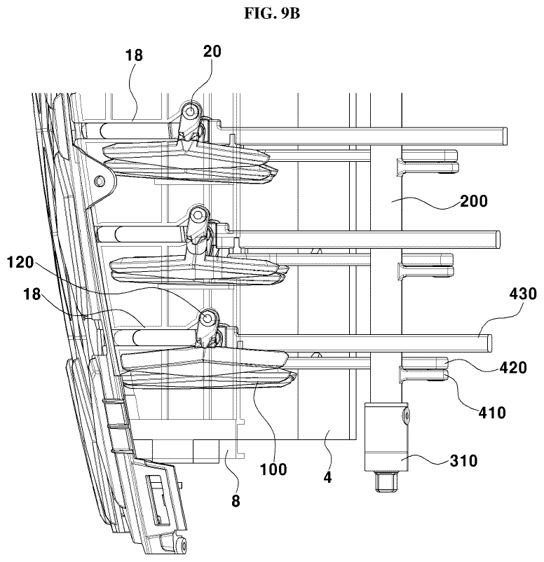

As illustrated in FIGS. 10A and 10B, according to an implementation of the present disclosure, the shape or length of the proximal link 410 and the distal link 420 may be differently formed in the lateral direction y of the vehicle V. Moreover, the length of the slide link 430 may also be adjusted. Accordingly, the flaps 100 arranged in a column may be sequentially opened or closed.

According to some implementations of the present disclosure, the distal link 420 may include a curved portion C1. Because the distal link 420 partially includes the curved portion C1, the rotational motion of the drive rod 200 may be converted into a linear motion of the slide link 430. As in the illustrated implementation, the position of the curved portion C1 in each of the distal links 420 arranged in the lateral direction (y-axis) of the vehicle V may vary. This allows the flaps 100 to be sequentially opened or closed column by column. In some implementations, the proximal link 410 may be omitted depending on the shape of the distal link 420. By adjusting the position of the curved portion C1 in the distal link 420, the proximal link 410 may be omitted and the distal link 420 may be directly mounted to the drive rod 200.

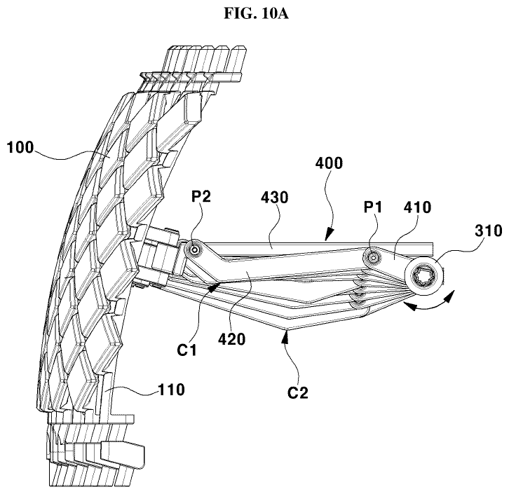

As described above, the active air flap device 1 according to the present disclosure may minimize the amount of internal components visible when viewed from the front of the vehicle V in the open position of the active air flap device 1 by including the simplified opening and closing structure of the flap 100. Therefore, as shown in FIG. 11, the active air flap device 1 may provide a neater appearance.

The active air flap device 1 according to the present disclosure may further include a controller 500. The controller 500 includes a processor and a memory. The memory may store computer-executable commands or instructions (e.g., executable software code) executable by specifically configured hardware or processors, such as the processor in the controller 500. In some implementations, some of the commands, when executed by the processor, may drive the actuator 300 to operate the flaps 100 in an opening mode. The opening mode is a process in which the flaps 100 are opened. In some implementations, some of the commands, when executed by the processor, may drive the actuator 300 to operate the flaps 100 in a closing mode. The closing mode is a process in which the flaps 100 that are open are closed. In some implementations, some of the commands, when executed by the processor, may operate the flaps 100 in a welcome mode. For example, the welcome mode is an operation mode of the flaps 100 that may be operated to welcome the driver of the vehicle V when the driver approaches the vehicle V. In some implementations, some commands, when executed by the processor, may cause the flaps 100 to operate in an emergency light mode. For example, the emergency light mode may cause the flaps 100 to operate in conjunction with the emergency light when the emergency light of the vehicle V is turned on.

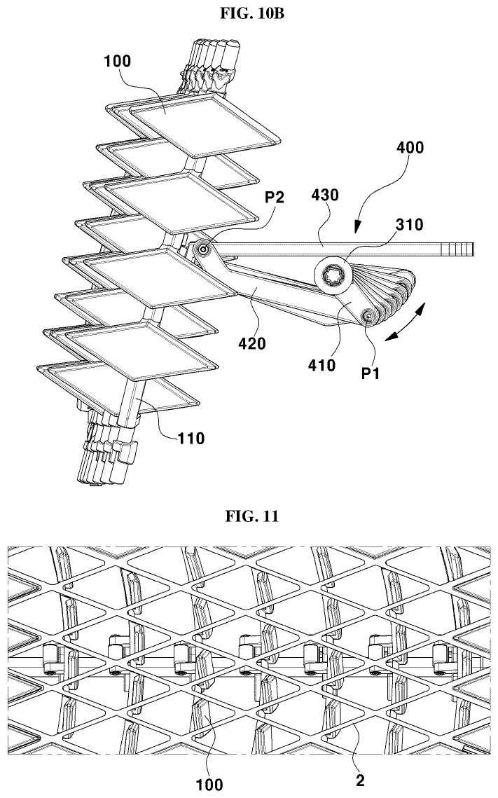

As illustrated in FIGS. 12A and 12B, the operation of the actuator 300 may be controlled differently in each mode. Specifically, the operation time of the actuator 300, the amount of rotation of a rotation shaft R1 by the actuator 300, or a combination thereof may be controlled differently. The amount of rotation of the rotation shaft R1 may be the amount of rotation of the drive rod 200. The opening amount of the flaps 100 may change depending on the amount of rotation of the drive rod 200. In some modes, the operation of a lighting feature may be controlled together with the actuator 300. Referring again to FIG. 5, in one implementation, the active air flap device 1 may further include a lighting strip, string or bar 600. As a non-limiting example, the lighting strip 600 may be a light emitting diode (LED) (or a series of LEDs). The lighting strip 600 may be placed at the rear of the flap 100. In one implementation, the lighting strip 600 may be turned on or off in conjunction with the operation of the flaps 100. In one implementation, the lighting strip 600 may be turned on only partially or may be turned on entirely. Furthermore, in some implementations, the lighting strip 600 may be turned on or off directionally from left to right or from right to left. According to an implementation of the present disclosure, the operation of the lighting strip 600 may be controlled by the controller 500.

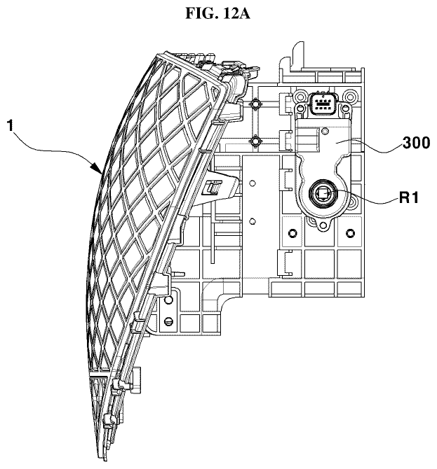

For example, the opening mode and the closing mode may be executed as shown in the graph of FIG. 13. When entering the opening mode, the controller 500 drives the actuator 300 to open the flaps 100. In one example, the driving time of the actuator 300 may be about 6 seconds, and the rotation amount of the rotation shaft R1 may be about 150°. When entering the closing mode, the controller 500 drives the actuator 300 to close the flaps 100. In one example, the driving time of the actuator 300 may be about 6 seconds, and the rotation amount of the rotation shaft may be −150°. Moreover, when the opening mode and the closing mode of the flaps 100 are operated in succession, a predetermined standby time (e.g., 2 seconds) may be included in the open state of the flap 100. In other words, the flaps 100 remain open for at least 2 seconds before being closed.

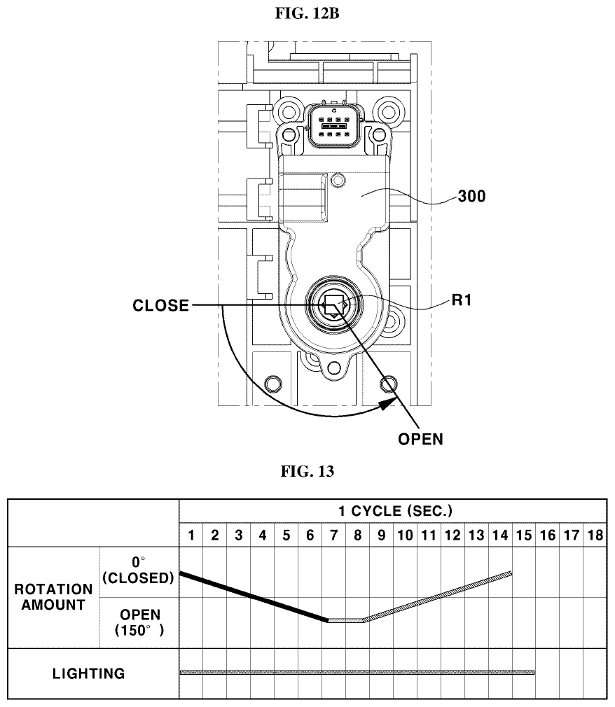

The welcome mode may be executed as shown in the graph of FIG. 14. In the welcome mode, the rotation amount of the rotation shaft R1, i.e., the opening amount of the flaps 100, may be made smaller than in the opening mode. In one example, the rotation amount is set to 90°. Moreover, the open state of the flaps 100 may be made longer than the standby time. Furthermore, the lighting (e.g., the lighting strip 600) may be controlled to be turned on in the welcome mode.

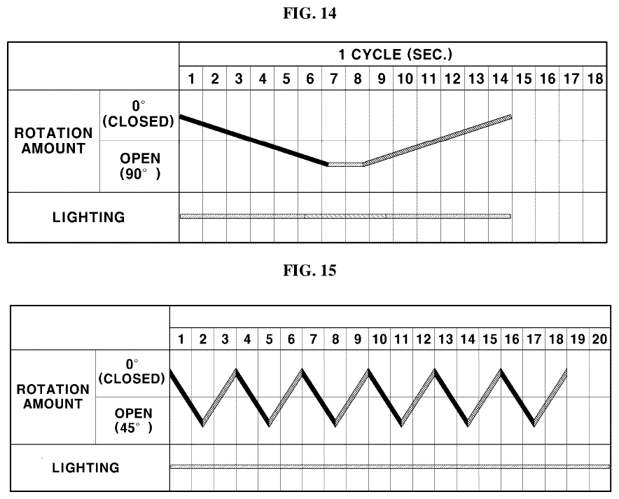

The emergency light mode may be executed as shown in the graph of FIG. 15. In the emergency light mode, the rotation amount of the rotation shaft R1 may be set smaller (e.g., 45°), and the flaps 100 may be repeatedly opened and closed. In the example shown in FIG. 15, the flaps 100 are repeatedly opened and closed without a standby time, such that the flaps 100 sequentially open and close with no pause in between. Moreover, the lighting may be controlled to be kept turned on. In one example, the lighting may be controlled such that the lighting is turned on and off to correspond with the flaps 100 opening and closing, such that the lighting is on when the flaps 100 are opened (or at least mostly opened) and the lighting is off when the flaps 100 are closed (or at least mostly closed).

The active air flap according to the present disclosure is configured to implement various exterior designs through the opening and closing operation of the flaps, thereby providing improved aesthetics and performing an information-transmission function.

According to the present disclosure, the flaps may be controlled to be sequentially opened or closed to thereby control the cooling area, which may complement the trade-off between reducing air resistance and improving cooling performance.

According to the present disclosure, the commercial value of the vehicle may be increased by implementing various operation modes of the flaps.

As is apparent from the above description, the present disclosure provides the following effects.

According to the present disclosure, an active air flap device capable of improving aerodynamic force performance of a vehicle is provided.

According to the present disclosure, an active air flap device capable of improving fuel efficiency or power efficiency of a vehicle is provided.

According to the present disclosure, an active air flap device having an aesthetic function and an information-transmission function as well as an improvement in aerodynamic force performance is provided.

Effects of the present disclosure are not limited to what has been described above, and other effects not mentioned herein should be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. An active air flap device, the device comprising:
a flap; and
a plurality of links configured to move the flap between an open position and a closed position,
wherein the plurality of links comprises:
a slide link coupled to the flap; and
a first link rotatably coupled to the slide link and configured to rotate to linearly move the slide link.

2. The device of claim 1, further comprising an actuator configured to provide a rotational force to the first link.

3. The device of claim 2, further comprising a drive rod configured to rotate by an operation of the actuator and rotatably connected to the first link.

4. The device of claim 3, wherein the first link further comprises a second link protruding radially outwardly from the drive rod and rotatably coupled to the first link.

5. The device of claim 1, wherein the flap comprises a coupling portion coupled to the slide link, and wherein the flap is rotatably coupled to the slide link by the coupling portion.

6. The device of claim 5, further comprising a guide passage configured to guide a movement of the coupling portion.

7. The device of claim 6, wherein the guide passage is formed in a housing configured to support the flap.

8. The device of claim 6, wherein the guide passage comprises:
a linear passage; and
an oblique passage extending at an angle with respect to the linear passage.

9. The device of claim 6, wherein the guide passage comprises:
an open end, wherein in the closed position the flap is disposed at the open end; and
a closed end, wherein in the open position the flap is disposed at the closed end, and
wherein the open end and the closed end are arranged substantially perpendicular to each other.

10. The device of claim 1, wherein the flap comprises a plurality of flaps arranged in a line and interconnected.

11. The device of claim 10, wherein the plurality of the flaps are connected to one another by a connecting portion extending along the plurality of the flaps.

12. The device of claim 10, wherein
the plurality of the flaps are arranged in a plurality of columns in a lateral direction, and
at least one of a length or a shape of a link of the plurality of links connected to each column in the plurality of columns of the flaps are variable.

13. The device of claim 1, further comprising a guide, wherein the slide link is insertable into the guide to guide a movement of the slide link.

14. The device of claim 13, wherein the guide is formed in a housing configured to support the flap.

15. The device of claim 1, wherein the device is configured to be mounted at a front grille portion of a vehicle.

16. The device of claim 1, wherein the device is configured to be mounted at a front bumper portion of a vehicle.

17. An active air flap device, the device comprising:
a flap;
a plurality of links configured to move the flap between an open position and a closed position;
an actuator configured to provide a rotational force to the plurality of links; and
a controller configured to control the actuator so that the flap executes one or more operation modes,
wherein the plurality of links comprises:
a slide link coupled to the flap; and
a first link rotatably coupled to the slide link and configured to rotate to linearly move the slide link.

18. The device of claim 17, wherein the controller is configured to control an operation of the actuator such that at least one of an opening amount of the flap and a time period that the flap is in the open position is different in each operation mode.

19. The device of claim 17, further comprising:
a drive rod connected to the actuator and rotatably connected to the first link.

20. The device of claim 19, further comprising a second link configured to interconnect the drive rod and the first link.
